(19) United States
(12) Patent Application Publication
(10) Pub. No.: US 2006/0224680 A1
(43) Pub. Date: Oct. 5, 2006

(54) Electronic mail sending and receiving apparatus, and electronic mail sending and receiving program

(75) Inventor: Hajime Terayoko, Asaka-shi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJI PHOTO FILM CO., LTD., Minami-Ashigara-shi (JP)

(21) Appl. No.: 11/389,180

(22) Filed: Mar. 27, 2006

(30) Foreign Application Priority Data
Mar. 30, 2005 (JP) 2005-098914

(51) Int. Cl. G06F 15/16

(52) U.S. Cl. 709/206

(57) ABSTRACT

According to the electronic mail sending and receiving apparatus of the present invention, it is possible to intelligently implement personal representation that is suited to individual users of electronic mail by converting a character string representing a person that is included in the body of an electronic mail into a predetermined image for sending, and converting a character string representing a person that is included in the body of an electronic mail that was received into a predetermined image.

### BACKGROUND OF THE INVENTION

1. Field of the Invention

The present invention relates to an electronic mail sending and receiving apparatus and to an electronic mail sending and receiving program, and more particularly to an electronic mail sending and receiving apparatus and to an electronic mail sending and receiving program that send and receive electronic mail containing images.

2. Description of the Related Art

In recent years, the use of electronic mail containing rich contents such as HTML (Hyper Body Markup Language), images or pictograms or the like is becoming widespread for electronic mail that is sent and received by mobile phones and the like. As an example thereof, technology has been proposed which substitutes the body of an electronic mail with an image or pictogram or the like. For example, Japanese Patent Application Laid-Open No. 2004-54471 discloses a communication terminal which converts into character images an emoticon string which represents facial expressions and emotions that are made to resemble faces in an electronic mail and displays the character images. Further, Japanese Patent Application Laid-Open No. 2004-302865 discloses an electronic mail processing server which converts character information containing a pictogram in an electronic mail that was received from a client terminal into an image that was associated with this character information and sends the image to a destination designated by the client terminal.

### SUMMARY OF THE INVENTION

However, although the communication terminal disclosed in Japanese Patent Application Laid-Open No. 2004-54471 richly expresses the emotion of a user by converting a previously registered emoticon into a character image, these character images is a fixed image that was previously registered and is not an image that specifically represents an individual user. Further, in the invention disclosed in the above Japanese Patent Application Laid-Open No. 2004-302865, images associated with character information are previously registered in an electronic mail processing server, and character information in an electronic mail that is received from a client terminal is then converted into an image in the electronic mail processing server and sent to the destination, however it is not possible for the destination client to select whether or not to convert character information in the electronic mail into an image.

The present invention was made in view of the above circumstances, and it is an object of this invention to provide an electronic mail sending and receiving apparatus and electronic mail sending and receiving program which can intelligently implement personal representation that is suited to individual users of electronic mail by converting character information in an electronic mail into a predetermined image for sending, and converting character information in an electronic mail that is received into a predetermined image.

In order to achieve the above object, an electronic mail sending and receiving apparatus according to a first aspect of the present invention comprises: an electronic mail sending and receiving device which performs sending and receiving of electronic mail; a character string and image storage device which associates and stores an image and a character string representing a person; a mail body analysis device which analyzes a body of the electronic mail to extract a character string that is stored in the character string and image storage device; and a character string and image conversion device which converts the extracted character string into an image that is associated with the character string.

According to the electronic mail sending and receiving apparatus of the first aspect, it is possible to intelligently implement personal representation that is suited to individual users of electronic mail by converting a character string representing a person that is included in the body of an electronic mail into a predetermined image for sending, and converting a character string representing a person that is included in the body of an electronic mail that was received into a predetermined image.

An electronic mail sending and receiving apparatus according to a second aspect is in accordance with the first aspect, wherein the image is a facial image of the person represented by the character string. The second aspect limits the types of image of the first aspect to a facial image.

An electronic mail sending and receiving apparatus according to a third aspect is in accordance with the first or second aspect, wherein the character string and image storage device stores an image of a user of the electronic mail sending and receiving apparatus, and when a character string that is extracted from an electronic mail to be sent from the electronic mail sending and receiving device is a character string representing the grammatical first person, the character string and image conversion device converts the character string representing the grammatical first person into the image of the user.

According to the electronic mail sending and receiving apparatus of the third aspect, it is possible to convert a character string representing the grammatical first person in an electronic mail for sending into an image of the user him/herself.

An electronic mail sending and receiving apparatus according to a fourth aspect is in accordance with the first, second or third aspect, wherein the character string and image storage device stores an image of a destination party for an electronic mail to be sent from the electronic mail sending and receiving device, and when a character string that is extracted from an electronic mail to be sent from the electronic mail sending and receiving device is a character string representing the grammatical second person, the character string and image conversion device converts the character string representing the grammatical second person into the image of the destination party.

According to the electronic mail sending and receiving apparatus of the fourth aspect, it is possible to convert a character string representing the grammatical second person in an electronic mail for sending into an image of the destination party.

An electronic-mail sending and receiving apparatus according to a fifth aspect is in accordance with any one of the first to fourth aspects, wherein the character string and image storage device stores an image of a user of the electronic mail sending and receiving apparatus, and when a character string that is extracted from an electronic mail that is received by the electronic mail sending and receiving device is a character string representing the grammatical second person, the character string and image conversion device converts the character string representing the grammatical second person into the image of the user.

According to the electronic mail sending and receiving apparatus of the fifth aspect, it is possible to convert a character string representing the grammatical second person in a received electronic mail into an image of the user him/herself.

An electronic mail sending and receiving apparatus according to a sixth aspect is in accordance with any one of the first to fifth aspects, wherein the character string and image storage device stores an image of a sender of an electronic mail that is received by the electronic mail sending and receiving device, and when a character string that is extracted from an electronic mail received by the electronic mail sending and receiving device is a character string representing the grammatical first person, the character string and image conversion device converts the character string representing the grammatical first person into an image of the sender.

According to the electronic mail sending and receiving apparatus of the sixth aspect, it is possible to convert a character string representing the grammatical second person in a received electronic mail into an image of the sender.

An electronic mail sending and receiving apparatus according to a seventh aspect is in accordance with any one of the first to sixth aspects, wherein the character string and image storage device stores a plurality of images of the person in correspondence with various types of character strings representing the person, and the character string and image conversion device converts the extracted character string into an image of the person that corresponds with the type of character string representing the person.

According to the electronic mail sending and receiving apparatus of the seventh aspect, it is possible to create an electronic mail in which an image that better suits the body was inserted, for example, by associating an image of the person in formal clothing when the character string representing the person is a polite (formal) expression and associating an image of the person in rough clothing when the character string representing the person is a colloquial expression.

An electronic mail sending and receiving apparatus according to an eighth aspect is in accordance with any one of the first to seventh aspects, wherein the character string and image conversion device replaces the extracted character string with the image. The eighth aspect limits a mode that converts a character string into an image to replacement.

An electronic mail sending and receiving apparatus according to an ninth aspect is in accordance with the eighth aspect, further comprising a designating device that designates the image, wherein when the image that replaces the extracted character string is designated by the designating device, the character string and image conversion device attaches a pop-up displaying the replaced character string to the image.

According to the electronic mail sending and receiving apparatus of the ninth aspect, when a character string was replaced with an image, it is possible to check the character string as it existed before the replacement by designating the image using a cursor or the like.

An electronic mail sending and receiving apparatus according to a tenth aspect is in accordance with the first to seventh aspects, wherein the character string and image conversion device inserts the image in front or rear of the extracted character string. The tenth aspect limits a mode that converts a character string into an image to insertion into body.

An electronic mail sending and receiving apparatus according to an eleventh aspect is in accordance with the first to tenth aspects, wherein the mail body analysis device does not perform extraction of the character string for a quoted portion in body of the electronic mail.

According to the electronic mail sending and receiving apparatus of the eleventh aspect, it is possible to prevent a quotation portion from being inappropriately converted.

An electronic mail sending and receiving program according to a twelfth aspect causes a computer to implement: an electronic mail sending and receiving function which performs sending and receiving of electronic mail; a character string and image storage function which associates and stores an image and a character string representing a person; a mail body analysis function which analyzes a body of the electronic mail to extract the stored character string; and a character string and image conversion function which converts the extracted character string into an image that is associated with the character string.

By applying software or firmware that includes the electronic mail sending and receiving program of the twelfth aspect in a PC, PDA or mobile phone, it is possible to realize the electronic mail sending and receiving apparatus of the present invention.

According to the present invention it is possible to intelligently implement personal representation that is suited to individual users of electronic mail by converting a character string representing a person that is included in the body of an electronic mail into a predetermined image, and converting a character string representing a person that is included in the body of a received electronic mail into a predetermined image.

### BRIEF DESCRIPTION OF THE DRAWINGS

FIG. 1 is a block diagram that shows an electronic mail sending and receiving apparatus according to one embodiment of the present invention;

FIG. 2 is a table for illustrating a correlation between a user of an electronic mail sending and receiving apparatus 10 and a facial image of the user;

FIG. 3 is a table for illustrating a correlation between parties for sending and receiving of electronic mail and their facial images;

FIGS. 4A and 4B are views for illustrating an editing screen for electronic mail in the electronic mail sending and receiving apparatus 10;

FIG. 5 is a view that shows an example of a pop-up display;

FIG. 6 is a view that shows an example of inserting a facial image in a character string;

FIG. 7 is a flowchart for illustrating the flow of processing when converting a character string representing the grammatical first person to a facial image;

FIG. 8 is a table for illustrating a correlation between character strings representing the grammatical first person and facial images;

FIG. 9 is a flowchart for illustrating the flow of processing when converting a character string representing the grammatical second person to a facial image;

FIG. 10 is a flowchart for illustrating the flow of processing when converting a character string representing the name of a person to a facial image;

FIG. 11 is a view for illustrating a reply mail in a recipient's terminal that is not the electronic mail sending and receiving apparatus 10 of this invention;

FIG. 12 is a view for illustrating a reply mail as received in the electronic mail sending and receiving apparatus 10 of this invention;

FIGS. 13A and 13B are views for illustrating an editing screen for electronic mail in the electronic mail sending and receiving apparatus 10 of a user named “Suzuki”; and

FIGS. 14A and 14B are views for illustrating an editing screen for a reply mail in the terminal of a recipient named “Yamamoto”.

### DETAILED DESCRIPTION OF THE PREFERRED EMBODIMENTS

Hereunder, preferred embodiments of the electronic mail sending and receiving apparatus and an electronic mail sending and receiving program of the present invention are described in accordance with the attached drawings.

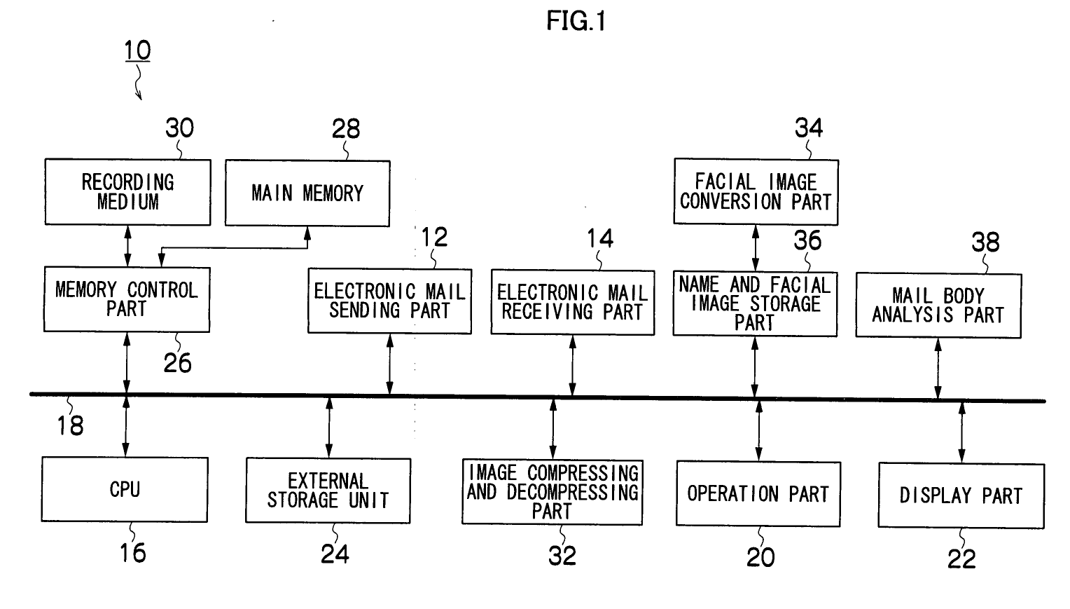

FIG. 1 is a block diagram that shows an electronic mail sending and receiving apparatus according to one embodiment of the present invention. An electronic mail sending and receiving apparatus 10 shown in FIG. 1 sends electronic mail to the terminal of a recipient through an electronic mail sending part 12, and receives electronic mail through an electronic mail receiving part 14. In this connection, although in the following description an example will be described in which the electronic mail sending and receiving apparatus 10 of the present invention is applied to a personal computer (PC), in addition to a PC the electronic mail sending and receiving apparatus 10 of the present invention can also be applied to, for example, a personal digital assistant (PDA) or a mobile phone that has a function for sending and receiving electronic mail.

In FIG. 1, a CPU (Central Processing Unit) 16 is connected to each block in the electronic mail sending and receiving apparatus 10 through a bus 18, and serves as a central control unit which performs centralized control over each block based on operation input from an operation part 20 and the like. The operation part 20 includes a keyboard, mouse or other operating member, and outputs a signal to the CPU 16 in accordance with operation input from these operating members.

A display part 22 is a display for displaying various data or an operating menu or the like and, for example, it includes a CRT (Cathode Ray Tube) monitor, LCD (Liquid Crystal Display) or organic EL (electroluminescence).

An external storage unit 24 is a device which stores programs to be processed by the CPU 16 and various data necessary for control and, for example, it consists of a hard disk device (HDD).

A memory control part 26 is controlled by the CPU 16 and writes data to a main memory 28 and a recording medium 30, and reads data from the main memory 28 and the recording medium 30.

The main memory 28 is the main storage unit of the electronic mail sending and receiving apparatus 10 and, for example, is a semiconductor memory. The main memory 28 comprises an SDRAM (Synchronous Dynamic Random Access Memory) that serves as a work area when the CPU 16 reads out various data or a program from the external storage unit 24 to perform various operations and the like, and a VRAM (Video Random Access Memory) that serves as a storage area that stores contents to be displayed on the display part 22, and the like.

The recording medium 30 records an image that was imaged by a digital camera or the like. A user can input a desired image into the electronic mail sending and receiving apparatus 10 through the recording medium 30.

An image compressing and decompressing part 32 performs compressing processing and decompressing processing of an image according to a predetermined method, for example, a JPEG (Joint Photographic Experts Group) method.

A facial image conversion part 34 uses facial recognition technology to extract a facial region from the above image and perform trimming of the facial region. The facial image conversion part 34 then converts the image (facial image) of the facial region that was trimmed to a predetermined size and stores the converted image in a name and facial image storage part 36. In this connection, when the profile of a face in the facial image can be extracted to enable a distinction between the face and the background, an image in which a background region of the facial image was made transparent by the facial image conversion part 34 may be stored in the name and facial image storage part 36.

Information of a user of the electronic mail sending and receiving apparatus 10 and sending and receiving parties for electronic mail are stored in association with the facial images thereof in the name and facial image storage part 36. A mail body analysis part 38 analyzes the body of an electronic mail that was input from the operation part 20 to extract a predetermined character string (for example, a character string including a pronoun for the grammatical first person or the grammatical second person, or a name that can identify a person). The mail body analysis part 38 then converts the extracted predetermined character string to a facial image that corresponds with that character string.

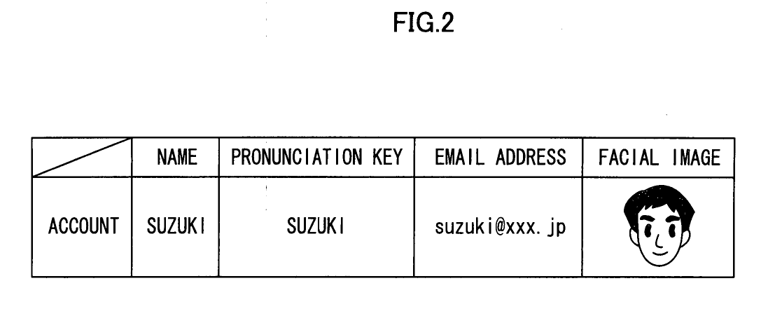

FIG. 2 is a table which illustrates the correlation between a user of the electronic mail sending and receiving apparatus 10 and a facial image of the user. In a table 50 shown in FIG. 2, the electronic mail account information (name, electronic mail address, password (not shown) and the like) of a user (Mr. Suzuki) of the electronic mail sending and receiving apparatus 10 is stored in association with a facial image of the user. In this connection, regarding the facial image of the user, in addition to a mode which registers the facial image in a file that manages electronic mail account information, as shown in FIG. 2, a configuration may also be adopted which stores the facial image in signature data, electronic business card data or an address book or the like.

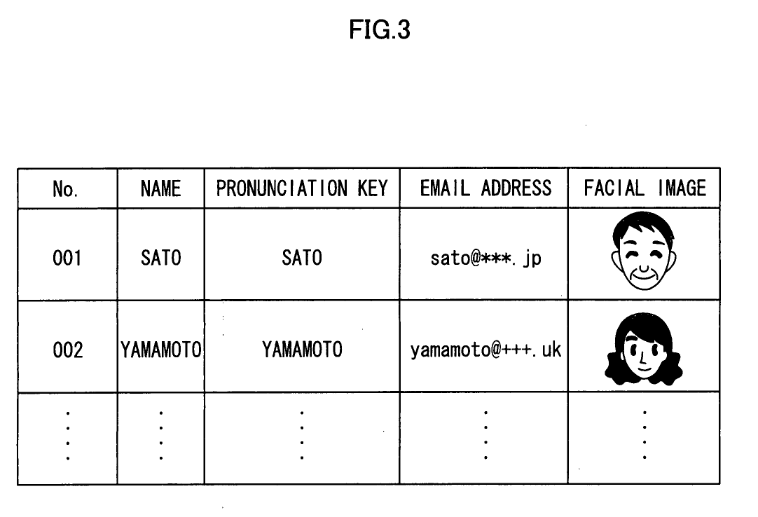

FIG. 3 is a table which illustrates a correlation between parties for sending and receiving of electronic mail and their facial images. A table 52 shown in FIG. 3 is, for example, an address book of an electronic mail software. In the table 52, the names, electronic mail addresses and the like of parties (Mr. Sato, Ms. Yamamoto, etc.) for sending and receiving of electronic mail are stored in association with their facial images.

According to this embodiment, since it is possible to convert a character string including the name of a person that is contained in the body of an electronic mail into a predetermined image and send the image, it is possible to intelligently implement personal representation that is suited to individual users of electronic mail.

In this connection, although in the example shown in FIG. 3 a configuration is adopted which stores the correlation between parties for sending and receiving and their facial images in a table 52 of an address book, for example, a function may be provided that stores the correlation between a name or electronic mail address of a person and their facial image in a location other than an address book. Further, the main body of an electronic mail can be represented in a richer and more varied manner by, for example, storing an image in association with the name of a person other than a sending or receiving party (for example, a celebrity such as an entertainer, athlete or statesman) or a character, landscape, object, business name, brand name or emblem.

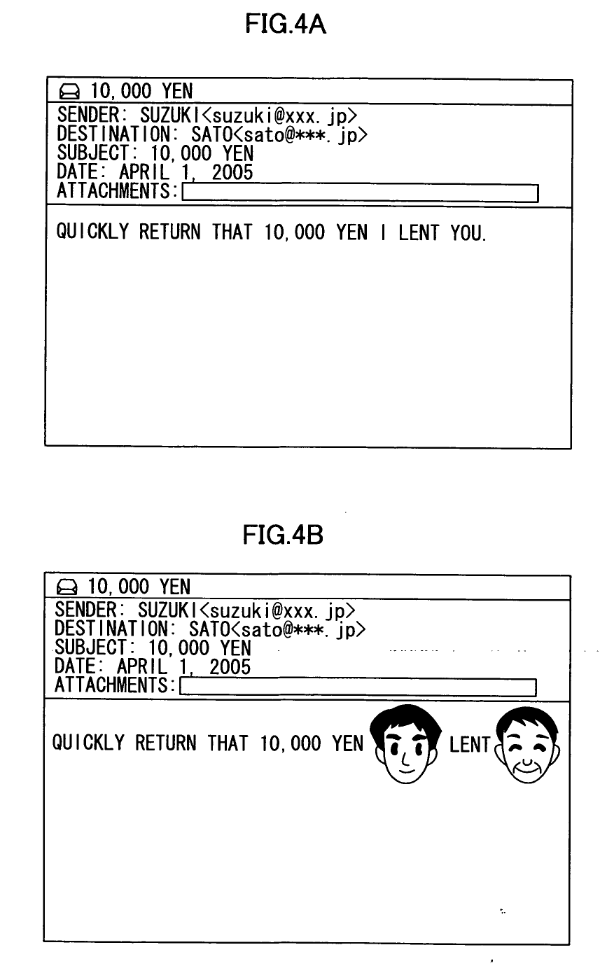

Hereunder, the flow of processing when sending or receiving electronic mail using the electronic mail sending and receiving apparatus 10 of this embodiment will be described. FIGS. 4A and 4B are views for illustrating an editing screen for electronic mail in the electronic mail sending and receiving apparatus 10. As shown in FIG. 4A, when the body and destination of an electronic mail are input, the body of the electronic mail is analyzed by the mail body analysis part 38 to extract a character string including a pronoun for the grammatical first person or grammatical second person, or a predetermined character string of a name or the like that can identify a person. The extracted character string is then converted to a predetermined facial image. In the example shown in FIG. 4B, the character string “I” that represents the grammatical first person is converted to the facial image of the user “Suzuki” who is the sender, and the character string “you” that represents the grammatical second person is converted to the facial image of the destination party “Sato” (see FIG. 2 and FIG. 3). As a method for embedding a facial image in the body of an electronic mail, for example, a method can be employed that uses an img tag by adopting HTML format for the electronic mail.

When embedding a facial image into the body of an electronic mail the size of the facial image is adjusted (reduced or enlarged) in accordance with the font or size of the body characters and the length of the sentence and the like. The facial image is also processed to obtain the optimal image quality or file size in accordance with the destination of the electronic mail or the total number of facial images included in the body of the electronic mail. For example, when the destination of an electronic mail is a mobile phone, the facial image is processed so that the image quality is lowered in accordance with the display performance of the mobile phone (i.e. the file size is reduced).

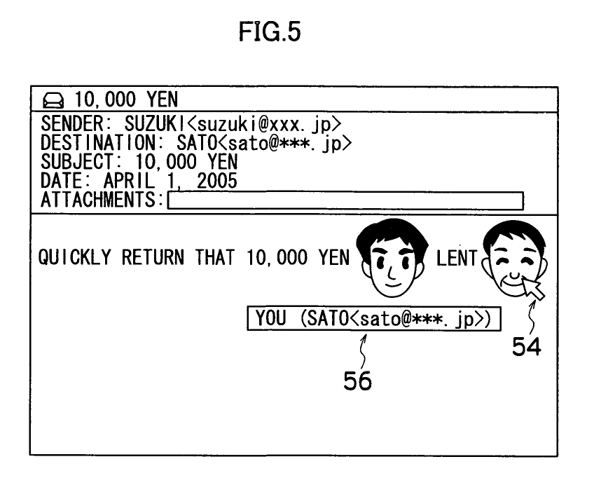

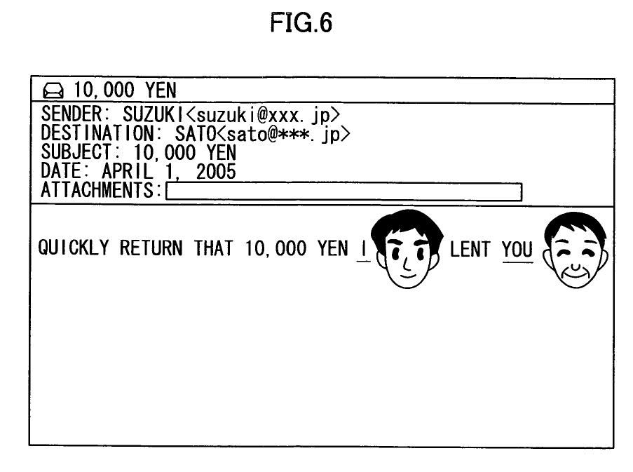

In this embodiment, as shown in FIG. 5, a configuration may be adopted whereby when a facial image is selected by a cursor 54 on an editing screen for an electronic mail, the character string (“I” or “you”) that existed prior to conversion is displayed by a pop-up 56. In the case of a HTML mail, this pop-up 56 can be displayed by utilizing a title property of an img tag that is used for embedding a facial image in the body of an electronic mail. A configuration may also be adopted whereby the name of the corresponding user, sending or receiving party, or electronic mail address is displayed in the pop-up 56 together with a character string such as “I” or “you”. Further, as shown in FIG. 6, instead of replacing a character string such as “I” or “you” with a facial image, a facial image that corresponds to the character string may be inserted in front or rear of the relevant character string. A configuration may be adopted whereby the user can select which method among the conversion methods from FIG. 4B to FIG. 6 to use.

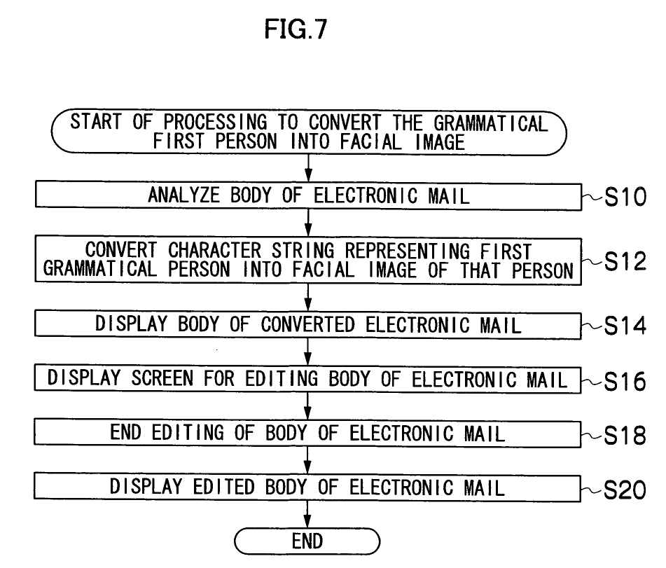

Next, the flow of processing when converting a predetermined character string into a facial image will be described referring to FIG. 7 and subsequent drawings. FIG. 7 is a flowchart for illustrating the flow of processing when converting a character string representing the grammatical first person into a facial image.

First, when the destination and body of an electronic mail are input, the body of the electronic mail is analyzed by the mail body analysis part 38 (step S10). Next, a character string representing the grammatical first person is extracted from the body of the electronic mail. Thereafter, a facial image of the user is read from a table 50 of the name and facial image storage part 36 to convert the extracted character string into the facial image of the user of the electronic mail sending and receiving apparatus 10 (step S 12). For example, in step S 12 a common pronoun for the grammatical first person such as “I”, “myself” or “mine” is extracted as a character string that represents the grammatical first person and is converted into a facial image. Further, in step S12, a specific character string (for example, a proper name or nickname) representing the grammatical first person that was previously registered by the user may be converted.

Next, the body of the electronic mail that was converted in step S 12 is displayed in an unconfirmed state (preview) that is not confirmed by the user (step S14), and an editing screen for the body of the electronic mail is displayed (step S16). In this connection, in step S14, highlighting may be performed that, for example, underlines or frames the portion with the converted facial image. In the editing screen (see FIG. 4B etc.) of step S16, converted facial images can be sequentially selected each time a button (for example, an arrow key or confirmation (Return or Enter) key) which moves the cursor is pressed. When the result of converting the body of the electronic mail in step S12 is not in accordance with the intention of the user, the user can select the facial image on the editing screen of step S16 to return to the character string, or can replace the selected facial image with a different image. The user can also select whether to replace a character string with a facial image, whether to set the pop-up 56, or whether to insert a facial image in front or rear of a character string.

Thereafter, when a predetermined operating member is operated to complete editing of the body of the electronic mail (step S18), the result of converting the electronic mail body is displayed (step S20). The electronic mail that was confirmed by a predetermined operation is then sent to a predetermined destination. Thus, a character string representing the grammatical first person that is included in the body of the electronic mail is converted into a facial image of the user.

In this connection, in the above step S12, a configuration may be adopted whereby data for the body of past electronic mails of the user is mined to extract a character string that represents the grammatical first person from that data, and the extracted character string is scored. As a result, information can be obtained regarding sentence patterns or sentence habits of the user from archives of past electronic mail. Thus, for example, since the usage frequency of character strings representing the grammatical first person, such as a user mainly using a character string “mine” or “myself,” can be obtained, more accurate and faster conversion processing can be performed.

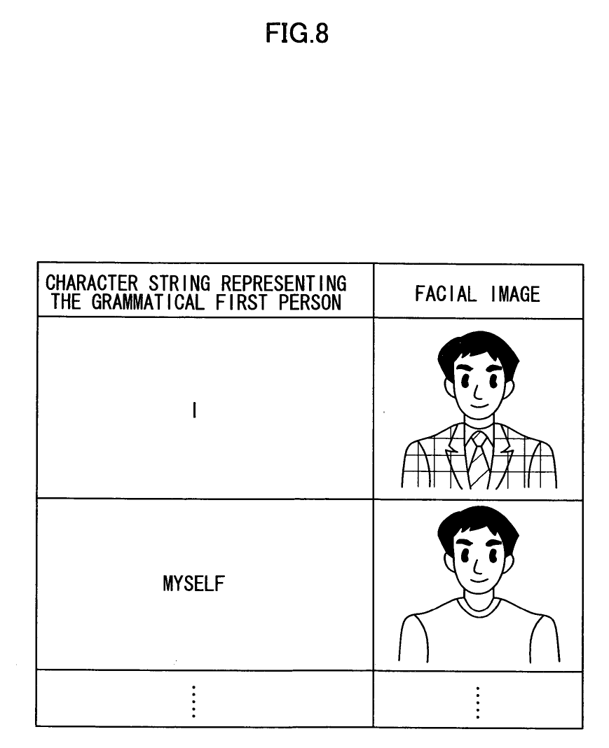

Further, in the above step S12, for example, a facial image with a different facial expression or different clothing may be allocated for each character string that represents the grammatical first person. FIG. 8 is a table for illustrating a correlation between character strings representing the grammatical first person and facial images. In the example shown in the figure, a photograph taken when wearing a suit is allocated for the character string “I,” and photograph taken when wearing causal clothes (a sweat shirt) is allocated for the character string “myself.” It is thus possible to use the proper facial image in accordance with the polite expression “I” and the expression “myself” that is used for a party with which the user is on friendly terms.

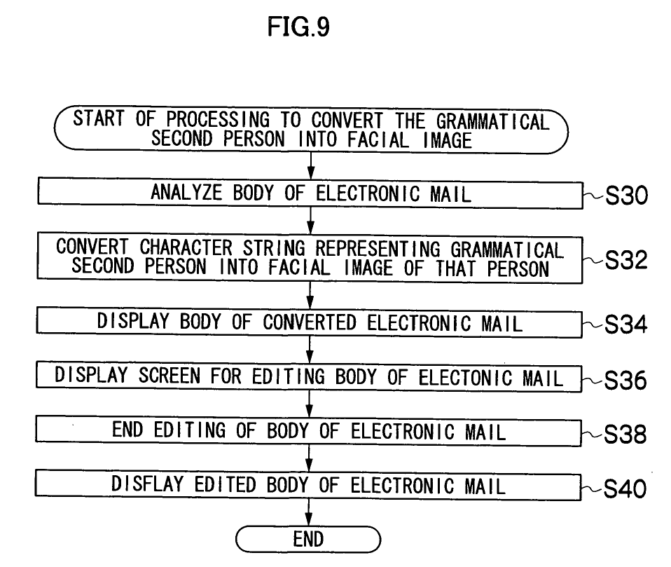

Next, processing that converts a character string representing the grammatical second person into a facial image will be described. FIG. 9 is a flowchart for illustrating the flow of processing when converting a character string representing the grammatical second person into a facial image. First, when the destination and body of an electronic mail are input, the body of the electronic mail is analyzed by the mail body analysis part 38 (step S30). Next, a character string representing the grammatical second person is extracted from the body of the electronic mail (step S32). In this case, for example, a common pronoun that represents the grammatical second person such as “you”, “dear” or “darling” is extracted as a character string that represents the grammatical second person. Further, a specific character string (for example, a proper name or nickname) that represents the grammatical second person that was previously registered by the user may be extracted.

Subsequently, when the destination (destination party) of the electronic mail is set, a facial image of the destination party is read from the table 52 of the name and facial image storage part 36, and the extracted character string is converted to the facial image of the destination party of the electronic mail (step S32). When destination parties were set by separation into “To (the stated destination)”, “CC (Carbon Copy)” and “Bcc (Blind Carbon Copy)”, the extracted character string representing the grammatical second person is converted into a facial image of the destination party that is set in “To”. When a plurality of destinations is set in “To”, for example, the extracted character string representing the grammatical second person may be converted into a facial image of the destination party that is set at the start of the destination field. In this example, a converted facial image can be edited in step S36 to be performed later.

Next, the process proceeds to step S34. The subsequent processing from step S34 to step S40 is the same as that from step S14 to step S20 in the above FIG. 7, and a description thereof is thus omitted here. As a result, a character string representing the grammatical second person that is included in the body of the electronic mail is converted into the facial image of the destination party.

In the aforementioned step S32, a configuration may be adopted whereby data for the body of past electronic mails of the user is mined to extract a character string that represents the grammatical second person from the data, and the extracted character string is then scored. As a result, information can be obtained regarding sentence patterns or sentence habits of the user from archives of past electronic mail. Thus, for example, since the usage frequency of character strings representing the grammatical second person, such as the user mainly using the character string “darling,” can be obtained, more accurate and faster conversion processing can be performed.

Further, in the above step S32, similarly to the above described example, different facial images may be allocated for each character string that represents the grammatical second person (see FIG. 8).

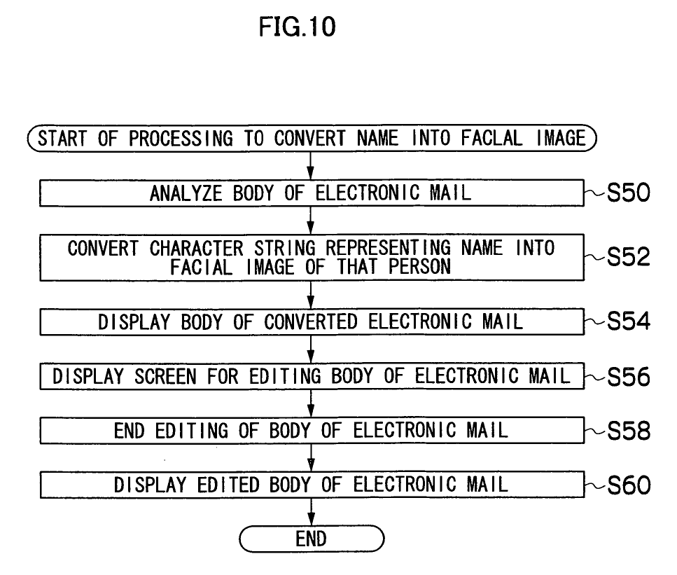

Next, processing which converts a character string representing the name of a person into a facial image will be described. FIG. 10 is a flowchart for illustrating the flow of processing when converting a character string representing the name of a person into a facial image. First, when the destination and body of an electronic mail are input, the body of the electronic mail is analyzed by the mail body analysis part 38 (step S50). Next, a character string representing the name of a person is extracted from the body of the electronic mail to specify the person represented by the extracted character string. Thereafter, a facial image corresponding to the person is read from the table 52 of the name and facial image storage part 36 to convert the extracted character string into this facial image (step S52). In this case, a character string representing a person may be, in addition to the aforementioned name of the destination party of the electronic mail (for example, a full name, nickname or pet name), for example, the name of a celebrity such as an entertainer or athlete that was previously registered in the name and facial image storage part 36, and these names can be extracted and converted into a corresponding facial image.

Next, the process proceeds to step S54. The subsequent processing from step S54 to step S60 is the same as that from step S14 to step S20 in the above FIG. 7, and a description thereof is thus omitted here. As a result, a character string representing the name of a person that is included in the body of the electronic mail is converted into a facial image that corresponds with the name of the person.

Further, in the above step S52, similarly to the above described examples, a plurality of facial images and character strings representing a person may be allocated for each person (see FIG. 8).

As described in the foregoing, an electronic mail in which a predetermined character string that is included in the body was converted into a facial image or image corresponding to that character string is sent to a destination party. When sending the electronic mail for which this conversion is completed, for example, a tag indicating that the aforementioned predetermined character string has been converted into a predetermined image is written in a HTML header.

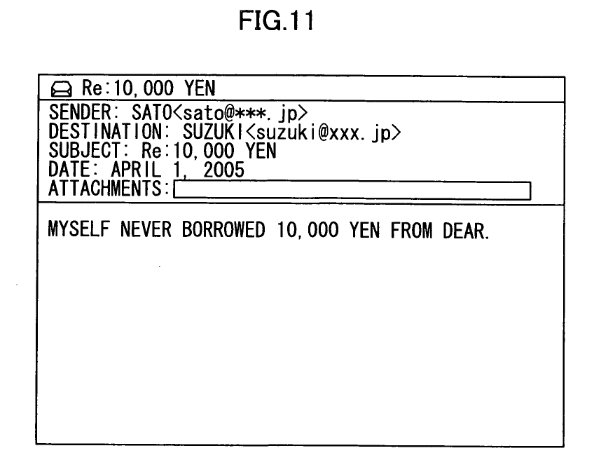

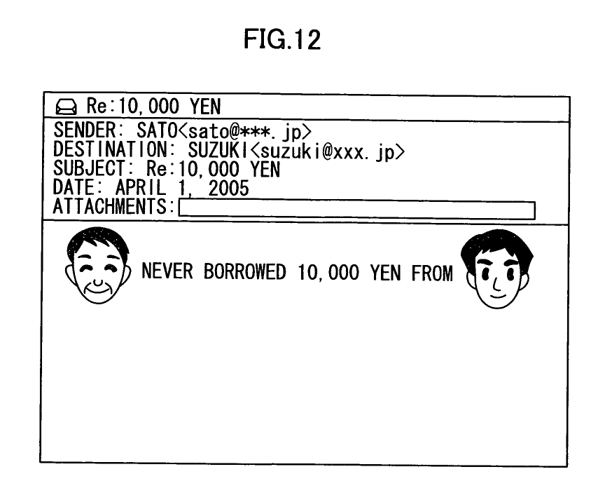

Hereunder, processing at the terminal of a recipient that received an electronic mail as shown in the above FIG. 4B and the like is described. First, a case in which the terminal of the recipient is not the electronic mail sending and receiving apparatus 10 of this invention will be described referring to FIG. 11 and FIG. 12. When a receiving terminal that is not the electronic mail sending and receiving apparatus 10 of this invention receives the above described converted electronic mail, the body of an electronic mail containing facial images as shown in the above described FIG. 4B, FIG. 5 and FIG. 6 is displayed as it is on the display screen of the terminal of the recipient “Sato.”

FIG. 11 is a view for illustrating a reply mail in a receiving terminal that is not the electronic mail sending and receiving apparatus 10 of this invention, and FIG. 12 is a view for illustrating a reply mail as received in the electronic mail sending and receiving apparatus 10 of this invention. As shown in FIG. 11, a reply mail consisting of only a character string is sent from the terminal of the recipient “Sato”. In this case, as shown in FIG. 12, this reply mail is converted and displayed in the electronic mail sending and receiving apparatus 10 of the user “Suzuki” who received the reply mail. In the example shown in FIG. 12, the character string “myself” representing the grammatical first person is converted into a facial image of the sender (replier) “Sato” of the reply mail, and the character string “dear” representing the grammatical second person is converted into a facial image of the user “Suzuki” as the destination of the reply mail. As described above, for a received electronic mail, a character string representing the grammatical first person is converted into a facial image of the sender and a character string representing the grammatical second person is converted into a facial image of the user of the electronic mail sending and receiving apparatus 10 of this invention as the destination (recipient, and sender of original electronic mail).

As described above, according to this embodiment, even for an electronic mail that was sent from a terminal that is not the electronic mail sending and receiving apparatus 10 of this invention, it is possible to convert a character string representing a person into a facial image in the same manner as in the case of an outbound mail. In this connection, conversion of a character string representing the name of a person is the same as in the example of FIG. 10 described above, and a description thereof is thus omitted here.

Next a case is described in which the recipient's terminal is the electronic mail sending and receiving apparatus 10 of this invention. In the following description, it is assumed that the “Suzuki” is the user of the electronic mail sending and receiving apparatus 10 of this invention, and “Yamamoto” is the recipient who possesses an electronic mail sending and receiving apparatus 10 according to this invention.

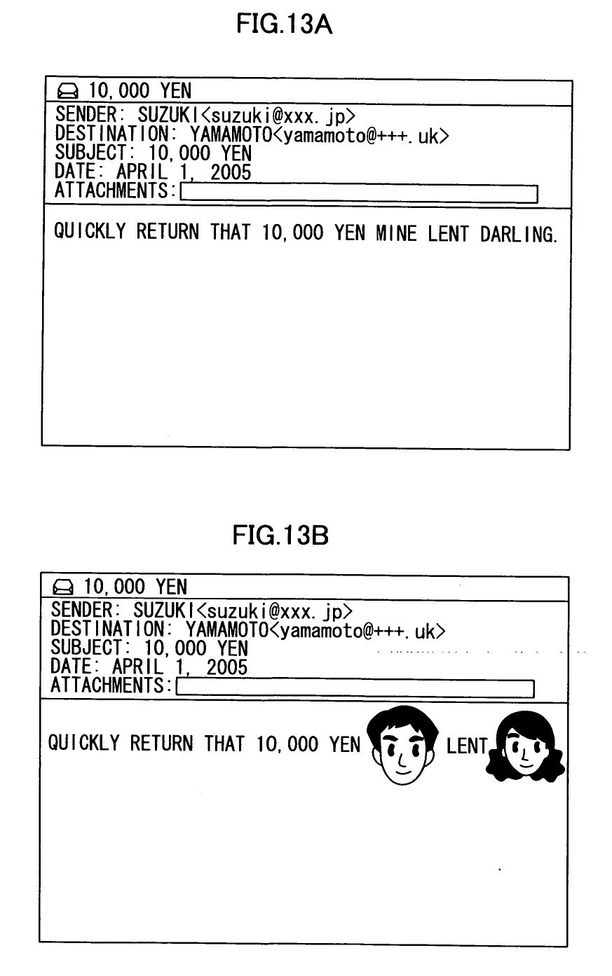

FIGS. 13A and 13B are views for illustrating an editing screen for electronic mail in the electronic mail sending and receiving apparatus 10 of the user “Suzuki”. Similarly to the example in FIGS. 4A and 4B, when the destination and body of an electronic mail are input (FIG. 13A), the body of the electronic mail is analyzed by the mail body analysis part 38 to extract predetermined character strings, and the extracted character strings are converted into predetermined facial images (FIG. 13B). In the example of FIGS. 13A and 13B, the character string “mine” representing the grammatical first person is converted into a facial image of the sender “Suzuki,” and the character string “darling” representing the grammatical second person is converted into a facial image of the destination “Yamamoto” (see FIG. 2 and FIG. 3).

When this electronic mail is received by the recipient “Yamamoto”, the header of the electronic mail is read. As described above, since a tag indicating that the electronic mail was converted is written in the header of this converted electronic mail, the electronic mail sending and receiving apparatus 10 of the recipient “Yamamoto” recognizes that the electronic mail was converted. Thus, the main body of the electronic mail as shown in the aforementioned FIG. 13B is displayed as it is on the display part 22 of the electronic mail sending and receiving apparatus 10 of the recipient “Yamamoto” without being converted by the electronic mail sending and receiving apparatus 10 of the recipient “Yamamoto.”

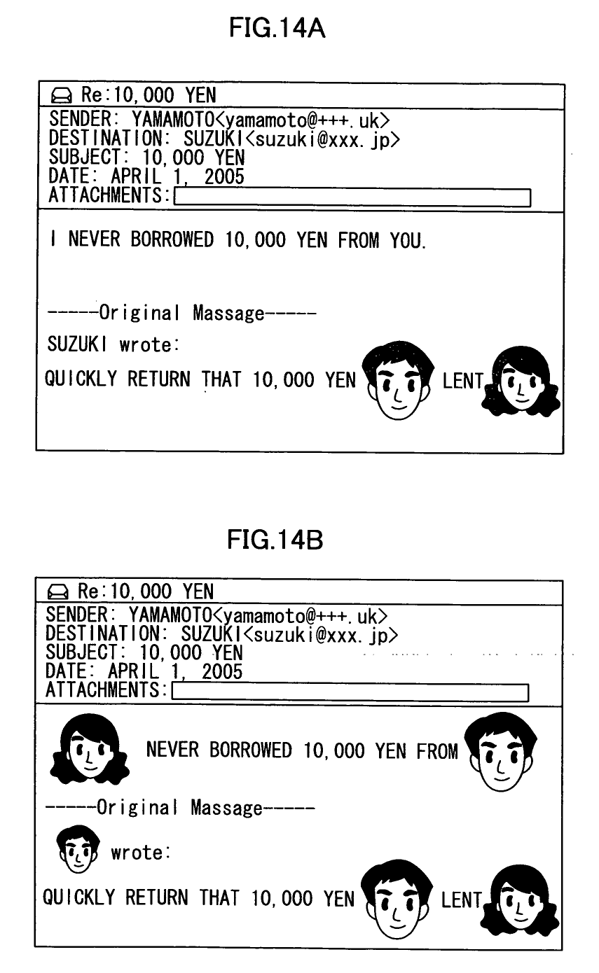

Next, a case will be described in which the recipient “Yamamoto” replies to this electronic mail. FIGS. 14A and 14B are views for illustrating an editing screen for a reply mail in the terminal of the recipient “Yamamoto”. As shown in FIG. 14A, when the destination and body of a reply mail are input in the electronic mail sending and receiving apparatus 10 of the recipient “Yamamoto,” the body of the electronic mail is analyzed by the mail body analysis part 38 to extract predetermined character strings. Subsequently, as shown in FIG. 14B, the extracted character strings are converted into predetermined facial images. In the example shown in FIG. 14B, the character string “I” representing the grammatical first person is converted into a facial image of the sender of the reply mail “Yamamoto,” and the character string “you” representing the grammatical second person is converted into a facial image of the destination of the reply mail (sender of original electronic mail) “Suzuki”.

As described in the foregoing, according to this embodiment, when an electronic mail is received that was sent from the electronic mail sending and receiving apparatus 10 of this invention, the electronic mail is displayed in accordance with the intention of the sender “Suzuki” without duplicate conversion being performed by the recipient's terminal.

In this connection, although in this example no change is made to the facial images of the original electronic mail that is quoted, a facial image may be used for a quotation sign as shown in FIG. 14B.

Further, in this embodiment a configuration may be adopted whereby a signature included in the body of an electronic mail is not converted into a facial image.

Furthermore, the electronic mail sending and receiving apparatus of this invention can be implemented by applying software or firmware containing a program which performs the above described processing to a PC, PDA or mobile phone.

What is claimed is:

1. An electronic mail sending and receiving apparatus, comprising:
an electronic mail sending and receiving device which performs sending and receiving of electronic mail;
a character string and image storage device which associates and stores an image and a character string representing a person;
a mail body analysis device which analyzes a body of the electronic mail to extract a character string that is stored in the character string and image storage device; and
a character string and image conversion device which converts the extracted character string into an image that is associated with the character string.

2. The electronic mail sending and receiving apparatus according to claim 1, wherein the image is a facial image of a person that is represented by the character string.

3. The electronic mail sending and receiving apparatus according to claim 1, wherein
the character string and image storage device stores an image of a user of the electronic mail sending and receiving apparatus, and
when a character string that is extracted from an electronic mail to be sent from the electronic mail sending and receiving device is a character string representing the grammatical first person, the character string and image conversion device converts the character string representing the grammatical first person into the image of the user.

4. The electronic mail sending and receiving apparatus according to claim 2, wherein
the character string and image storage device stores an image of a user of the electronic mail sending and receiving apparatus, and
when a character string that is extracted from an electronic mail to be sent from the electronic mail sending and receiving device is a character string representing the grammatical first person, the character string and image conversion device converts the character string representing the grammatical first person into the image of the user.

5. The electronic mail sending and receiving apparatus according to claim 1, wherein
the character string and image storage device stores an image of a destination party of an electronic mail to be sent from the electronic mail sending and receiving device, and
when a character string that is extracted from an electronic mail to be sent from the electronic mail sending and receiving device is a character string representing the grammatical second person, the character string and image conversion device converts the character string representing the grammatical second person into the image of the destination party.

6. The electronic mail sending and receiving apparatus according to claim 4, wherein
the character string and image storage device stores an image of a destination party of an electronic mail to be sent from the electronic mail sending and receiving device, and
when a character string that is extracted from an electronic mail to be sent from the electronic mail sending and receiving device is a character string representing the grammatical second person, the character string and image conversion device converts the character string representing the grammatical second person into the image of the destination party.

7. The electronic mail sending and receiving apparatus according to claim 1, wherein
the character string and image storage device stores an image of a user of the electronic mail sending and receiving apparatus, and
when a character string that is extracted from an electronic mail that is received by the electronic mail sending and receiving device is a character string representing the grammatical second person, the character string and image conversion device converts the character string representing the grammatical second person into the image of the user.

8. The electronic mail sending and receiving apparatus according to claim 6, wherein
the character string and image storage device stores an image of a user of the electronic mail sending and receiving apparatus, and
when a character string that is extracted from an electronic mail that is received by the electronic mail sending and receiving device is a character string representing the grammatical second person, the character string and image conversion device converts the character string representing the grammatical second person into the image of the user.

9. The electronic mail sending and receiving apparatus according to claim 1, wherein
the character string and image storage device stores an image of a sender of an electronic mail that is received by the electronic mail sending and receiving device, and
when a character string that is extracted from an electronic mail that is received by the electronic mail sending and receiving device is a character string representing the grammatical first person, the character string and image conversion device converts the character string representing the grammatical first person into the image of the sender.

10. The electronic mail sending and receiving apparatus according to claim 8, wherein
the character string and image storage device stores an image of a sender of an electronic mail that is received by the electronic mail sending and receiving device, and
when a character string that is extracted from an electronic mail that is received by the electronic mail sending and receiving device is a character string representing the grammatical first person, the character string and image conversion device converts the character string representing the grammatical first person into the image of the sender.

11. The electronic mail sending and receiving apparatus according to claim 1, wherein
the character string and image storage device stores a plurality of images of the person in correspondence with various types of character strings representing the person, and
the character string and image conversion device converts the extracted character string into an image of the person that corresponds with the type of character string that represents the person.

12. The electronic mail sending and receiving apparatus according to claim 10, wherein
the character string and image storage device stores a plurality of images of the person in correspondence with various types of character strings representing the person, and
the character string and image conversion device converts the extracted character string into an image of the person that corresponds with the type of character string that represents the person.

13. The electronic mail sending and receiving apparatus according to claim 1, wherein the character string and image conversion device replaces the extracted character string with the image.

14. The electronic mail sending and receiving apparatus according to claim 12, wherein the character string and image conversion device replaces the extracted character string with the image.

15. The electronic mail sending and receiving apparatus according to claim 13, further comprising a designating device that designates the image, wherein
when the image that replaces the extracted character string is designated by the designating device, the character string and image conversion device attaches a pop-up that displays the replaced character string to the image.

16. The electronic mail sending and receiving apparatus according to claim 14, further comprising a designating device that designates the image, wherein
when the image that replaces the extracted character string is designated by the designating device, the character string and image conversion device attaches a pop-up that displays the replaced character string to the image.

17. The electronic mail sending and receiving apparatus according to claim 1, wherein the character string and image conversion device inserts the image in front or rear of the extracted character string.

18. The electronic mail sending and receiving apparatus according to claim 12, wherein the character string and image conversion device inserts the image in front or rear of the extracted character string.

19. The electronic mail sending and receiving apparatus according to claim 1, wherein the mail body analysis device does not perform extraction of the character string for a quoted portion in body of the electronic mail.

20. The electronic mail sending and receiving apparatus according to claim 16, wherein the mail body analysis device does not perform extraction of the character string for a quoted portion in body of the electronic mail.

21. The electronic mail sending and receiving apparatus according to claim 18, wherein the mail body analysis device does not perform extraction of the character string for a quoted portion in body of the electronic mail.

22. An electronic mail sending and receiving program for causing a computer to implement:
an electronic mail sending and receiving function which performs sending and receiving of electronic mail;
a character string and image storage function which associates and stores an image and a character string representing a person;
a mail body analysis function which analyzes a body of the electronic mail to extract the stored character string; and
a character string and image conversion function which converts the extracted character string into an image that is associated with the character string.
